(19) United States
(12) Patent Application Publication
(10) Pub. No.: US 2010/0195234 A1
(43) Pub. Date: Aug. 5, 2010

(54) LUMINANCE-ENHANCED FILM

(75) Inventors: Yeon Soo Kim, Gyeonggi-do (KR); Deog Jae Jo, Gyeonggi-do (KR); Jin Soo Kim, Seoul (KR); Do Hyun Kim, Gyeonggi-do (KR); In Young Yang, Daejeon (KR)

Correspondence Address: ALSTON & BIRD LLP, BANK OF AMERICA PLAZA, 101 SOUTH TRYON STREET, SUITE 4000, CHARLOTTE, NC, 28280-4000, US

(73) Assignee: Woongjin Chemical Co., Ltd.

(21) Appl. No.: 12/693,662

(22) Filed: Jan. 26, 2010

(30) Foreign Application Priority Data
Jan. 30, 2009 (KR) 10-2009-0007647
Jan. 30, 2009 (KR) 10-2009-0007648
Jan. 30, 2009 (KR) 10-2009-0007649
Jan. 30, 2009 (KR) 10-2009-0007650

(51) Int. Cl. G02B 5/00

(52) U.S. Cl. 359/896

(57) ABSTRACT

Disclosed is a luminance-enhanced film, including birefringent island-in-the-sea yarns which comprise island portions and sea portions, each composed of a specific material. Accordingly, unlike conventional stack-type luminance-enhanced films, the luminance-enhanced film of the present invention comprises birefringent island-in-the-sea yarn, as a layer, in the sheet, thus considerably improving luminance without forming a plurality of layers. In addition, several hundred layers are not laminated on one film and the film can be easily fabricated at considerably reduced costs. Furthermore, the luminance-enhanced film has considerably more birefringent interfaces, as compared to films fabricated by conventional methods wherein birefringent fibers are incorporated into sheets, thus considerably improving luminance-enhancement effects and being industrially applicable.

### CROSS REFERENCE TO RELATED APPLICATIONS

This application claims the benefit under 35 U.S.C. §119(a) of Korean Patent Application Serial No. 10-2009-0007647, filed Jan. 30, 2009, Korean Patent Application Serial No. 10-2009-0007648, filed Jan. 30, 2009, Korean Patent Application Serial No. 10-2009-0007649, filed Jan. 30, 2009, and Korean Patent Application Serial No. 10-2009-0007650, filed Jan. 30, 2009, all of which are incorporated herein by reference in their entirety.

### BACKGROUND OF THE INVENTION

1. Technical Field

The present invention relates to a luminance-enhanced film, and more specifically, to a luminance-enhanced film in which birefringent island-in-the-sea yarns comprising a specific ingredient are present in a sheet, to considerably reduce production costs and remarkably increase luminance.

2. Background Art

Liquid crystal displays (LCDs), projection displays and plasma display panels (PDPs) which have already secured their markets in the TV field are main for flat panel display technology. It is also expected that field emission displays (FEDs), electro-luminescent displays (ELDs), etc. will gain market share according to their respective characteristics along with the improvement of technologies associated therewith. The application range of LCDs currently expands to notebooks, personal computer monitors, liquid crystal TVs, vehicles, aircrafts, etc. LCDs occupy about 80% of the flat panel market and global sales are strong these days along with the sharply increased demand since the second half of 1998.

Conventional LCDs have a structure in which liquid crystal and an electrode matrix are disposed between a pair of light-absorbent optical films. In LCDs, the liquid crystal is moved by an electric field generated by applying an electric voltage to two electrodes and thus has an optical state depending on the electric field. This process displays an image by polarizing pixels storing information in a specific direction. For this reason, LCDs include a front optical film and a rear optical film to induce this polarization.

LCD devices do not necessarily have a high use efficiency of light emitted from a backlight. This is because 50% or more of the light emitted from the backlight is absorbed by a rear-side optical film. Accordingly, in order to increase the use efficiency of the backlight light in LCD devices, a luminance-enhanced film is interposed between an optical cavity and a liquid crystal assembly.

FIG. 1 is a view illustrating the optical principle of a conventional luminance-enhanced film.

More specifically, P-polarized light of light orienting from an optical cavity to a liquid crystal assembly is transferred through a luminance-enhanced film to the liquid crystal assembly and S-polarized light thereof is reflected from the luminance-enhanced film to the optical cavity, reflected from a diffusion reflection surface of the optical cavity in a state in which the polarization direction of the light becomes random, and then transferred to the luminance-enhanced film again. Consequently, the S-polarized light is converted into P-polarized light that can pass through a polarizer of the liquid crystal assembly and then transferred through the luminance-enhanced film to the liquid crystal assembly.

Selective reflection of the S-polarized light with respect to the incident light on the luminance-enhanced film and transmission of the P-polarized light are carried out by the difference in refractive index between respective optical layers, determination of an optical thickness of each optical layer according to extension of stacked optical layers and variation in the refractive index of the optical layer, in the state in which a flat-sheet optical layer having an anisotropic refractive index and a flat-sheet optical layer having an isotropic refractive index are alternately stacked in plural number.

That is, the light incident on the luminance-enhanced film undergoes the reflection of the S-polarized light and the transmission of the P-polarized light, while passing through the receptive optical layers. As a result, only the P-polarized light of the incident polarized light is transferred to the liquid crystal assembly. Meanwhile, the reflected S-polarized light is reflected from the diffusion reflection surface of the optical cavity in the state in which its polarization state becomes random as mentioned above and then transferred to the luminance-enhanced film again. Accordingly, loss of light generated from a light source and waste of power can be reduced.

However, this conventional luminance-enhanced film is fabricated by alternately stacking flat sheet-shaped isotropic optical layers and flat sheet-shaped anisotropic optical layers, which have different refractive indices, and performing an extension process on the stacked structure so that the stacked layer has an optical thickness and a refractive index of the respective optical layers, which can be optimized for selective reflection and transmission of incident polarized light. Accordingly, this fabrication process had a disadvantage of complicated fabrication of the luminance-enhanced film. In particular, since each optical layer of the luminance-enhanced film has a flat-sheet shape, P-polarized light and S-polarized light have to be separated from each other in response to a wide range of an incident angle of the incident polarized light. Accordingly, this film has a structure in which an excessively increased number of optical layers are stacked, thus disadvantageously involving exponential increase in production costs. In addition, this structure disadvantageously causes optical loss and thus deterioration in optical performance. Accordingly, when birefringent fibers are arranged in a sheet, light emitted from a light source is reflected, scattered and refracted on the birefringent interface between the birefringent fiber and the isotropic sheet, thus inducing optical modulation and improving luminance. However, luminance-enhanced films fabricated using general birefringent fibers have advantages of low production costs and easy production, since they are not fabricated in a stack-structure, but disadvantageously cannot improve luminance to a desired level and are unsuitable for application to industrial fields, instead of the afore-mentioned stack-type luminance-enhanced-film.

Therefore, the present invention has been made in view of the above problems, and it is one object of the present invention to provide a luminance-enhanced film to considerably enhance luminance.

It is another object of the present invention to provide a liquid crystal display with enhanced luminance, comprising the luminance-enhanced film.

### SUMMARY OF THE INVENTION

In accordance with the present invention, the above and other objects can be accomplished by the provision of: a luminance-enhanced film including: a sheet; and a plurality of birefringent island-in-the-sea yarns arranged in the sheet, wherein each island-in-the-sea yarn comprises island portions composed of polyethylene naphthalate (PEN) and a sea portion composed of a material selected from copolyethylene naphthalate (co-PEN), polycarbonate (PC), a polycarbonate alloy and a combination thereof.

The sheet may be isotropic.

The polycarbonate alloy may consist of polycarbonate and modified polycyclohexylenedimethylene terephthalate glycol (PCTG). More preferably, the polycarbonate and the modified polycyclohexylenedimethylene terephthalate glycol (PCTG) may be present in a weight ratio of 15:85 to 85:15. Most preferably, the polycarbonate and the modified polycyclohexylenedimethylene terephthalate glycol (PCTG) may be present in a weight ratio of 4:6 to 6:4.

The island portion may be birefringent and the sea portion may be isotropic. A difference in refractive index between the sheet and the island-in-the-sea yarn with respect to two axial directions may be 0.05 or less and a difference in refractive index between the sheet and the island-in-the-sea yarn with respect to the remaining one axial direction may be 0.1 or more.

Assuming that x-, y- and z-axis refractive indexes of the sheet are nX1, nY1 and nZ1, respectively, and the x-, y- and z-axis refractive indexes of the island-in-the-sea yarn are nX2, nY2 and nZ2, respectively, at least one of x-, y- and z-axis refractive indexes of the sheet may be equivalent to that of the birefringent island-in-the-sea yarn. More preferably, the refractive indexes of the birefringent island-in-the-sea yarn may be nX2>nY2=nZ2.

A difference in refractive index between the sea portion and the island portion with respect to two axial directions may be 0.05 or less and a difference in refractive index between the sea portion and the island portion with respect to the remaining one axial direction may be 0.1 or more.

Assuming that x- (longitudinal), y- and z-axis refractive indexes of the island portion are nX3, nY3 and nZ3, respectively, and the x-, y- and z-axis refractive indexes of the sea portion are nX4, nY4 and nZ4, respectively, at least one of x-, y- and z-axis refractive indexes of the island portion may be equivalent to that of the sea portion. An absolute value of the difference in refractive index between nX3 and nX4 may be 0.1 or more.

The refractive index of the sea portion in the island-in-the-sea yarns may be equivalent to the refractive index of the sheet.

An area ratio of the sea portion and the island portions may be 2:8 to 8:2, based on the cross-section of the island-in-the-sea yarn.

The luminance-enhanced film may have a structured surface layer.

The birefringent island-in-the-sea yarns may be woven into a fabric, the fabric is woven using the birefringent island-in-the-sea yarns as one of wefts and warps, and fibers as the other thereof, and the island portions may have a melting initiation temperature higher than a melting temperature of the fiber.

The fibers may be isotropic fibers and the fibers may be selected from the group consisting of polymer, natural and inorganic fibers and combinations thereof.

The fabric may be woven in an asymmetric structure such that more birefringent fibers than isotropic fibers are exposed to the surface of the fabric.

One isotropic fiber with respect to 5 to 16 birefringent fibers may be exposed in one direction to the surface of the fabric.

The fabric may be woven in an asymmetric structure such that 5 to 16 times as many birefringent fibers as isotropic fibers are exposed to the surface of the fabric.

The asymmetric structure of fabric may be woven with 40 to 240 fibers/inch of the birefringent fibers and 20 to 240 fibers/inch of the isotropic fibers.

The wefts or warps may be composed of 1 to 200 threads of the island-in-the-sea yarns.

In accordance with another aspect, provided is a liquid crystal display device including the luminance-enhanced film.

The liquid crystal display device may further include a reflection medium to re-reflect light modulated on the luminance-enhanced film.

Hereinafter, a brief description will be given of the terms used herein.

Unless specifically mentioned, the expression “fibers are birefringent” means that when light is irradiated to fibers having different refractive indices according to directions, the light incident to the fibers is refracted in two different directions.

The term “isotrope” means a property in which an object has a constant refractive index irrespective of a direction at which light passes through the object.

The term “anisotrope” means a property in which optical properties of an object are varied according to directions of light and an anisotropic object is birefringent and is contrary to isotrope.

The term “optical modulation” means a phenomenon in which irradiated light is reflected, refracted, or scattered, or intensity, wave cycle or characteristics thereof are varied.

The term “melting initiation temperature” means a temperature at which a polymer begins to melt, and the term “melting temperature” means a temperature at which melting occurs most rapidly. Accordingly, when a melting temperature of a polymer is observed by DSC, the temperature at which melting endothermic peak initially takes place is referred to as a “melting initiation temperature” and the temperature plotted at a maximum of the endothermic peak is referred to as a “melting temperature”.

### BRIEF DESCRIPTION OF THE DRAWINGS

The above and other objects, features and other advantages of the present invention will be more clearly understood from the following detailed description taken in conjunction with the accompanying drawings, in which:

FIG. 1 is a schematic view illustrating the principle of a conventional luminance-enhanced film;

FIG. 2 is a schematic view illustrating the cross-section of a luminance-enhanced film according to one embodiment of the present invention;

FIG. 3 is a sectional view illustrating a passage of light emitted to the birefringent island-in-the-sea yarns;

FIGS. 4 to 12 are cross-sectional views illustrating birefringent island-in-the-sea yarns according to one embodiment of the present invention;

FIG. 13 is a top view illustrating a fabric woven by birefringent island-in-the-sea yarns according to one embodiment of the present invention;

FIGS. 14 to 19 are sectional views illustrating the structured surface of the luminance-enhanced film according to the present invention;

FIG. 20 is a sectional view illustrating a spinneret to fabricate the birefringent island-in-the-sea yarns according to one preferred embodiment of the present invention;

FIG. 21 is a sectional view illustrating a spinneret to fabricate the birefringent island-in-the-sea yarns according to another preferred embodiment of the present invention; and

FIG. 22 is a schematic view illustrating an LCD device comprising the luminance-enhanced film according to the present invention.

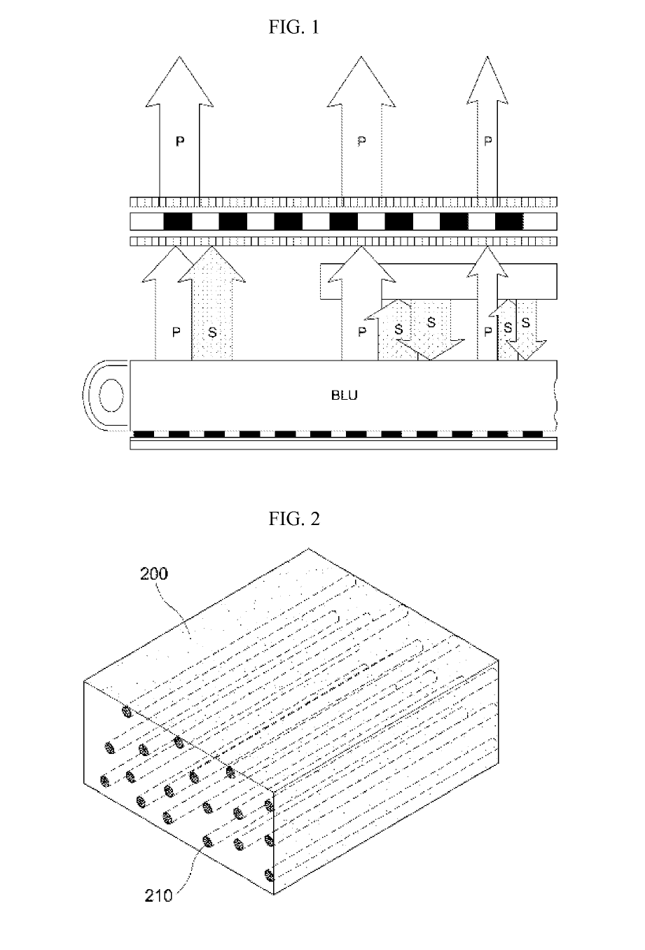

### DETAILED DESCRIPTION OF THE INVENTION

Unlike conventional stack-type luminance-enhanced films, the luminance-enhanced film of the present invention comprises birefringent island-in-the-sea yarns, as a layer, disposed in the sheet, thus considerably improving luminance without disposing a plurality of layers. In addition, several hundreds of layers are not laminated on one film and the film can be thus easily fabricated at considerably reduced costs. Furthermore, the luminance-enhanced film has considerably more birefringent interfaces, as compared to films fabricated by conventional methods wherein birefringent fibers are incorporated into sheets, thus considerably improving luminance-enhancement effects and having industrial applicability. Furthermore, the birefringent island-in-the-sea yarn comprising specific materials of the present invention exhibits the highest luminance improvement efficiency, as compared to conventional birefringent island-in-the-sea yarns.

In addition, the fabric included in the luminance-enhanced film of the present invention is woven in an asymmetric structure, thus minimizing presence of fabric patterns on the luminance-enhanced film and preventing occurrence of a moiré phenomenon.

Hereinafter, the present invention will be illustrated in more detail.

Light emitted from a light source is reflected, scattered and refracted on the birefringent interface between the birefringent fibers and the isotropic sheet, thereby inducing optical modulation and considerably improving luminance. Specifically, light emitted from an external light source may be largely divided into S-polarized light and P-polarized light. In the case in which only specific polarized light is required, the P-polarized light passes through a luminance-enhanced film without being influenced by the birefringent interface. However, the S-polarized light is modulated into a wavelength in a random refracted, scattered or reflected form, i.e., S-polarized light or P-polarized light on the birefringent interface. If the modulated light is reflected and irradiated on the luminance-enhanced film again, the P-polarized light passes through the luminance-enhanced film, and the S-polarized light is scattered or reflected again. Through repetition of this process, desired P-polarized light can be obtained. The case wherein birefringent fibers are incorporated into a sheet, based on this principle, instead of using conventional stack-type luminance-enhanced films has an advantage of low production costs and easy production, but disadvantageously cannot improve luminance to a desired level and is thus unsuitable for industrial application, instead of the conventional stack-type luminance-enhanced films.

Accordingly, the afore-mentioned problem can be solved by using birefringent island-in-the-sea yarns as birefringent fibers having birefringent interfaces. More specifically, the case where birefringent island-in-the-sea yarns are used is found to exhibit considerably improved optical modulation efficiency and luminance, as compared to the case where conventional birefringent fibers are used. Of the constituent components of island-in-the-sea yarns, the island portions are anisotropic and sea portions partitioning the island portions are isotropic. This case, where the interfaces between a plurality of island portions and a plurality of sea portions constituting the island-in-the-sea yarns as well as the interfaces between the island-in-the-sea yarns and the sheet are birefringent, exhibits considerably improved optical modulation efficiency and is thus industrially applicable as an alternative to stack-type luminance-enhanced films, as compared to conventional birefringent fibers wherein only the interfaces between the sheet and birefringent fibers are birefringent. Accordingly, as compared to the case where common birefringent fibers are used, the case where birefringent island-in-the-sea yarns are used exhibits superior optical modulation efficiency and birefringent island-in-the-sea yarns which comprise island portions and sea portions exhibiting different optical properties, thus enabling formation of birefringent interfaces therein, can more considerably improve optical modulation efficiency.

In addition, the birefringent island-in-the-sea yarns used herein utilize materials for island and sea portions, which are found to exhibit superior optical modulation effects, thus maximizing improvement in luminance, as compared to conventional island-in-the-sea yarns.

Furthermore, in the case where a composite fiber is prepared by twisting several to several tens of island-in-the-sea yarns, for example, a composite fiber is prepared by twisting 10 island-in-the-sea yarns, the composite fiber has 100 birefringent interfaces and thus causes at least 100 times of optical modulation. Furthermore, in the case where island-in-the-sea yarns interlaced with several threads are prepared, for example, island-in-the-sea yarns interlaced with 10 threads, the composite fiber prepared from the yarns has 100 birefringent interfaces and thus causes at least 100 times of optical modulation. The island-in-the-sea yarns of the present invention may be prepared by a method such as co-extrusion and is not limited thereto.

Accordingly, while conventional island-in-the-sea yarns utilize only island portions left behind after melting sea portions, as microfibers, irrespective of birefringency, the present invention utilizes island-in-the-sea yarns comprising sea portions and island portions having different optical properties, instead of melting the sea portions of island-in-the-sea yarns. In order to accomplish objects of the present invention, the present invention adopts the case where island portions are anisotropic and sea portions are isotropic and vice versa.

Hereinafter, the present invention will be illustrated in more detail with reference to the annexed drawings.

FIG. 2 is a schematic cross-sectional view illustrating a luminance-enhanced film according to the present invention. More specifically, the luminance-enhanced film has a structure in which birefringent island-in-the-sea yarns 210 are randomly arranged within an isotropic sheet 200. Materials for the sheet 200 that can be used in the present invention include thermoplastic and thermosetting polymers which can transmit a desired range of optical wavelengths. Preferably, the sheet 200 may be amorphous or semicrystalline and may include a monopolymer, a copolymer or a blend thereof. More specifically, examples of suitable sheets 31 include poly(carbonate) (PC); syndiotactic and isotacticpoly(styrene) (PS); alkyl styrene; alkyl such as poly(methyl methacrylate) (PMMA) and PMMA copolymers, aromatic and aliphatic pendant (meth)acrylate; ethoxide and propoxide (meth)acrylate; multi-functional (meth)acrylate; acrylated epoxy; epoxy; and other ethylene unsaturated compounds; cyclic olefin and cyclic olefin copolymers; acrylonitrile butadiene styrene (ABS); styrene acrylonitrile (SAN) copolymers; epoxy; poly(vinyl cyclohexane); PMMA/poly(vinyl fluoride) blends; poly(phenylene oxide) alloys; styrene block copolymers; polyimide; polysulfone; poly(vinyl chloride); poly(dimethylsiloxane) (PDMS); polyurethane; unsaturated polyester; polyethylene; poly(propylene) (PP); poly(alkane terephthalate) such as poly(ethylene terephthalate) (PET); poly(alkane naphthalate) such as poly(ethylene naphthalate) (PEN); polyamide; ionomers; vinyl acetate/polyethylene copolymers; cellulose acetate; cellulose acetate butyrate; fluoro polymers; poly(styrene)-poly(ethylene) copolymers; PET and PEN copolymers such as polyolefin PET and PEN; and poly(carbonate)/aliphatic PET blends. More preferably, examples of suitable sheets include polyethylene naphthalate (PEN), copolyethylene naphthalate (co-PEN), polyethylene terephthalate (PET), polycarbonate (PC), polycarbonate (PC) alloys, polystyrene (PS), heat-resistant polystyrene (PS), polymethyl methacrylate (PMMA), polybutylene terephthalate (PBT), polypropylene (PP), polyethylene (PE), acrylonitrile butadiene styrene (ABS), polyurethane (PU), polyimide (PI), polyvinyl chloride (PVC), styrene acrylonitrile (SAN) mixtures, ethylene vinyl acetate (EVA), polyamide (PA), polyacetal (POM), phenol, epoxy (EP), urea (UF), melanin (MF), non-saturated polyester (UP), silicon (Si), elastomers, cycloolefin polymers (COP, ZEON Co., Ltd. (Japan), JSR Co., Ltd. (Japan)) and combinations thereof. More preferably, the sheet 200 may be composed of the same material as the sea portion of birefringent island-in-the-sea yarns 210. Furthermore, the sheet 200 may also contain an additive, such as an antioxidant, a light stabilizer, a heat stabilizer, a lubricant, a dispersing agent, a UV absorber, white pigment, and a fluorescent whitening agent, so long as the additive does not damage physical properties as mentioned above.

Next, the birefringent island-in-the-sea yarns 210 included in the sheet 200 will be illustrated. Any birefringent island-in-the-sea yarns 210 may be used without limitation of the type so long as they comprise island portions and sea portions having different optical properties and are useful as yarns. Accordingly, the birefringent island-in-the-sea yarns 210 may be composed of the same material as the sheet 200 and examples thereof include poly(carbonate) (PC); syndiotactic and isotacticpoly(styrene) (PS); alkyl styrene; alkyl such as poly(methyl methacrylate) (PMMA) and PMMA copolymers, aromatic and aliphatic pendant (meth)acrylate; ethoxide and propoxide (meth)acrylate; multi-functional (meth)acrylate; acrylated epoxy; epoxy; and other ethylene unsaturated compounds; cyclic olefin and cyclic olefin copolymers; acrylonitrile butadiene styrene (ABS); styrene acrylonitrile (SAN) copolymers; epoxy; poly(vinyl cyclohexane); PMMA/poly(vinyl fluoride) blends; poly(phenylene oxide) alloys; styrene block copolymers; polyimide; polysulfone; poly(vinyl chloride); poly(dimethylsiloxane) (PDMS); polyurethane; unsaturated polyester; polyethylene; poly(propylene) (PP); poly(alkane terephthalate) such as poly(ethylene terephthalate) (PET); poly(alkane naphthalate) such as poly(ethylene naphthalate) (PEN); polyamide; ionomers; vinyl acetate/polyethylene copolymers; cellulose acetate; cellulose acetate butyrate; fluoro polymers; poly(styrene)-poly(ethylene) copolymers; PET and PEN copolymers such as polyolefin PET and PEN; and poly(carbonate)/aliphatic PET blends. More preferably, examples of suitable birefringent island-in-the-sea yarns 210 include polyethylene naphthalate (PEN), copolyethylene naphthalate (co-PEN), polyethylene terephthalate (PET), polycarbonate (PC), polycarbonate (PC) alloys, polystyrene (PS), heat-resistant polystyrene (PS), polymethyl methacrylate (PMMA), polybutylene terephthalate (PBT), polypropylene (PP), polyethylene (PE), acrylonitrile butadiene styrene (ABS), polyurethane (PU), polyimide (PI), polyvinyl chloride (PVC), styrene acrylonitrile (SAN) mixtures, ethylene vinyl acetate (EVA), polyamide (PA), polyacetal (POM), phenol, epoxy (EP), urea (UF), melanin (MF), non-saturated polyester (UP), silicon (Si), elastomers, cycloolefin polymers and combinations thereof. However, it is more preferable that when polyethylene naphthalate (PEN) is used as a material for island portions in the birefringent island-in-the-sea yarns 210 and a copolyethylene naphthalate and polycarbonate alloy alone or a combination thereof is used as a material for sea portions, luminance is greatly improved, as compared to birefringent island-in-the-sea yarns made of common materials. In particular, when the polycarbonate alloy is used as the sea portions, birefringent island-in-the-sea yarns with the most excellent optical modulation property can be prepared. In this case, the polycarbonate alloy may be preferably made of polycarbonate and modified polycyclohexylenedimethylene terephthalate glycol (PCTG) and more preferably, use of the polycarbonate alloy consisting of the polycarbonate and modified polycyclohexylenedimethylene terephthalate glycol (PCTG) which are present in a weight ratio of 15:85 to 85:15 is effective for improvement in luminance. When polycarbonate is present in an amount less than 15%, polymer viscosity required for spinning performance is excessively increased and use of a spinning machine is disadvantageously impossible, and when the polycarbonate is present in an amount exceeding 85%, a glass transition temperature increases and spinning tension increases, after discharge from a nozzle, thus making it difficult to secure spinning performance.

Most preferably, use of the polycarbonate alloy consisting of the polycarbonate and modified polycyclohexylenedimethylene terephthalate glycol (PCTG) which are present in a weight ratio of 4:6 to 6:4 is effective for improvement in luminance (See Table 1).

Meanwhile, methods for modifying isotropic materials into birefringent materials are well-known in the art and for example, polymeric molecules are oriented and materials thus become birefringent when they are drawn under suitable temperature conditions.

In the birefringent island-in-the-sea yarns according to another embodiment of the present invention, the island portions and sea portions may have different optical properties in order to maximize optical modulation efficiency, and more preferably, the island portions may be anisotropic and the sea portions may be isotropic.

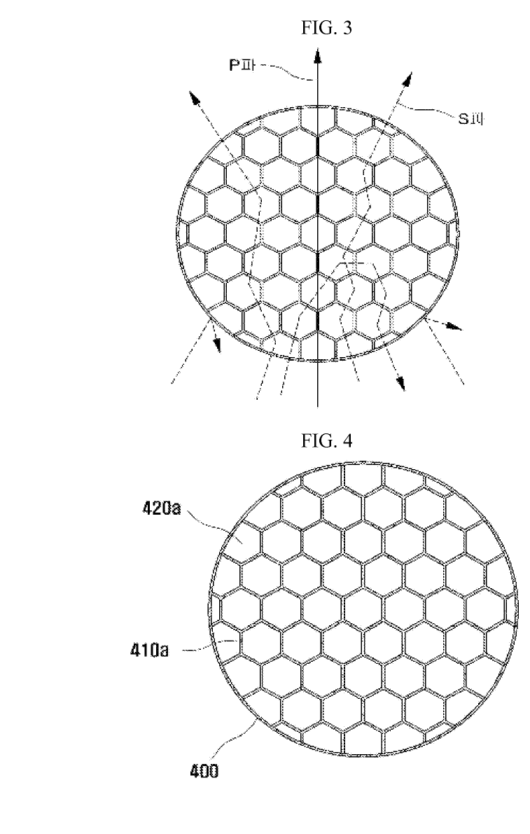

More specifically, in island-in-the-sea yarns comprising optically isotropic sea portions and anisotropic island portions, the levels of substantial equality and in-equality between refractive indexes along spatial axes X, Y and Z affect scattering of polarized light. Generally, scattering performance varies in proportion to the square of the difference in refractive index. Accordingly, as the difference in refractive index according to a specific axis increases, light polarized according to the axis is more strongly scattered. On the other hand, when the difference in refractive index according to a specific axis is low, a ray of light polarized according to the axis is weakly scattered. When the refractive index of sea portions at a specific axis is substantially equivalent to the refractive index of island portions, incident light that is polarized by an electric field parallel to this axis is not scattered, irrespective of the size, shape and density of a portion of the island-in-the-sea yarns, but may pass through the island-in-the-sea yarns. More specifically, FIG. 3 is a sectional view illustrating a passage in which light permeates birefringent island-in-the-sea yarns of the present invention. In this case, p waves (represented by lines) transmit island-in-the-sea yarns, independent from the interface between the outside and the birefringent island-in-the-sea yarns and the interface between island portions and sea portions present in birefringent island-in-the-sea yarns, while S waves (represented by dots) are affected by the interface between the sheet and the birefringent island-in-the-sea yarns and/or the interface between island portions and sea portions in the birefringent island-in-the-sea yarns and are thus optically modulated.

The afore-mentioned optical modulation phenomenon often occurs on the interface between the sheet and the birefringent island-in-the-sea yarns and/or the interface between island portions and sea portions in the birefringent island-in-the-sea yarns. More specifically, optical modulation occurs on the interface between the sheet and the birefringent island-in-the-sea yarn, like common birefringent fibers, when the sheet is optically isotropic. Specifically, the difference in refractive index between the sheet and the island-in-the-sea yarn with respect to two axial directions may be 0.05 or less and the difference in refractive index between the sheet and the island-in-the-sea yarn with respect to the remaining one axial direction may be 0.1 or more. Assuming that x-, y- and z-axis refractive indexes of the sheet are nX1, nY1 and nZ1, respectively, and the x-, y- and z-axis refractive indexes of the island-in-the-sea yarn are nX2, nY2 and nZ2, respectively, at least one of x-, y- and z-axis refractive indexes of the sheet may be equivalent to that of the birefringent island-in-the-sea yarn and the refractive indexes of island-in-the-sea yarns may be nX2>nY2=nZ2.

Meanwhile, of the birefringent island-in-the-sea yarns, the island portions and the sea portions preferably have different optical properties in view of formation of the birefringent interfaces. More specifically, when the island portions are anisotropic and the sea portions are isotropic, birefringent interfaces may be formed on the interface therebetween, and more specifically, it is preferred that the difference in refractive index in two axes is 0.05 or less and the difference in refractive index in the remaining axis is 0.1 or more. In this case, P waves pass through birefringent interfaces of island-in-the-sea yarns, while S waves cause optical modulation. More specifically, assuming that x- (longitudinal), y- and z-axis refractive indexes of the island portion are nX3, nY3 and nZ3, respectively, and the x-, y- and z-axis refractive indexes of the sea portion are nX4, nY4 and nZ4, respectively, it is preferred that at least one of x-, y- and z-axis refractive indexes of the island portion be equivalent to that of the sea portion and an absolute value of the difference in refractive index between nX3 and nX4 be 0.1 or more. Most preferably, when the difference in refractive index between sea portions and island portions in island-in-the-sea yarns in a longitudinal direction is 0.2 or more, and the refractive of the sea portions is substantially equivalent to the refractive of island portions in the remaining two axes, optical modulation efficiency can be maximized. Meanwhile, the case wherein the sheet and sea portions in the birefringent island-in-the-sea yarns have identical refractive indexes is advantageous for improving optical modulation efficiency.

With respect to the shape of the birefringent island-in-the-sea yarns, the cross-sections of the birefringent island-in-the-sea yarns may have any shape according to the intended applications and have various forms such as a circle, a spheroid or a polygon. Similarly, the cross-sections of the island portion of the island-in-the-sea yarn may have any shape and, for example, be circular or spheroidal, or non-circular such as a polygonal.

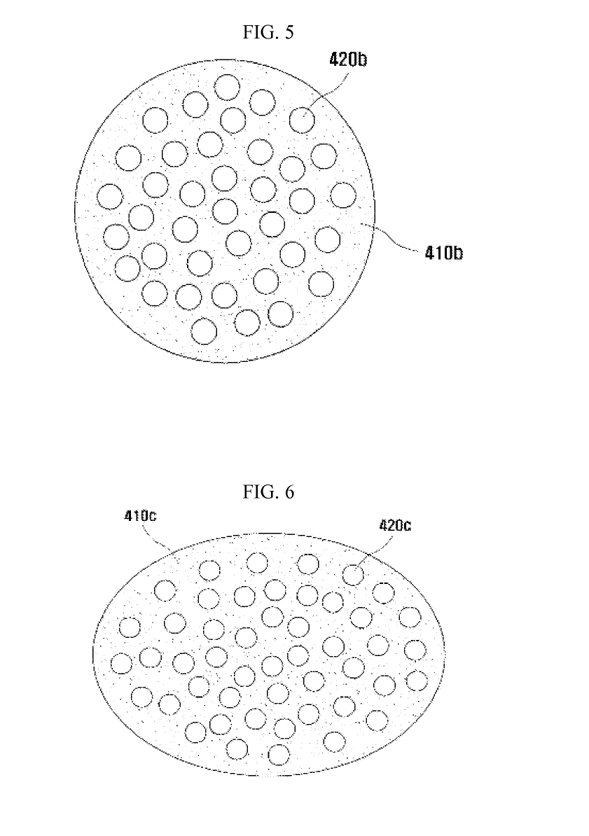

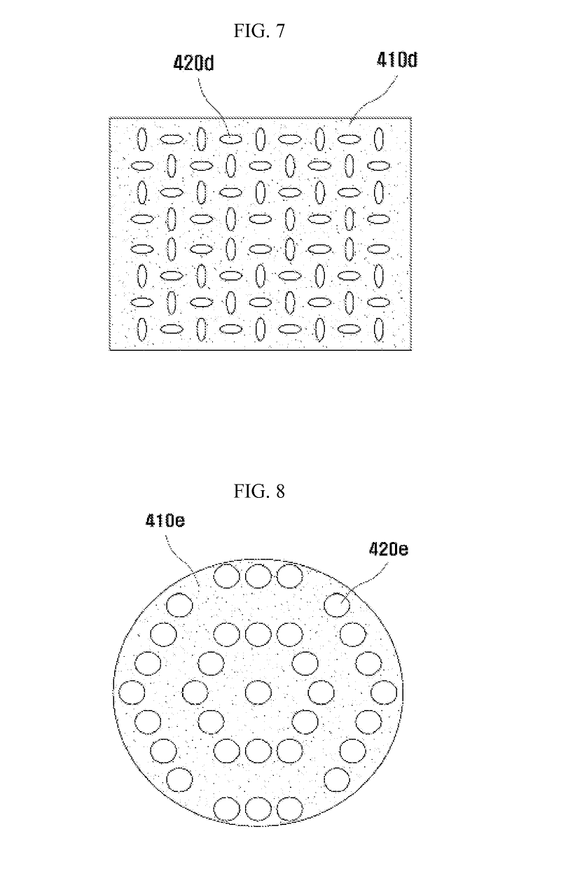

FIGS. 4 to 12 are cross-sectional views illustrating birefringent island-in-the-sea yarns according to one embodiment of the present invention. As can be seen from FIGS. 4 to 12, the shape, size, number and arrangement of the island portions may be efficiently controlled according to optical modulation purpose. FIG. 4 is a sectional view of a conventional birefringent island-in-the-sea yarn wherein circle-like island portions 420a are partitioned by a sea portion 410a. FIG. 5 is a cross-sectional view of a conventional island-in-the-sea yarn wherein the area of the sea portion 410b is larger than that of the island portions 420b. FIG. 6 is a cross-sectional view of an island-in-the-sea yarn whose shape is oval. In FIG. 7, the island portion 420d has an oval shape and the island portions are arranged in zigzags. Further, the cross-section of the island-in-the-sea yarn has a rectangular structure, but may have a polygonal or non-circular structure.

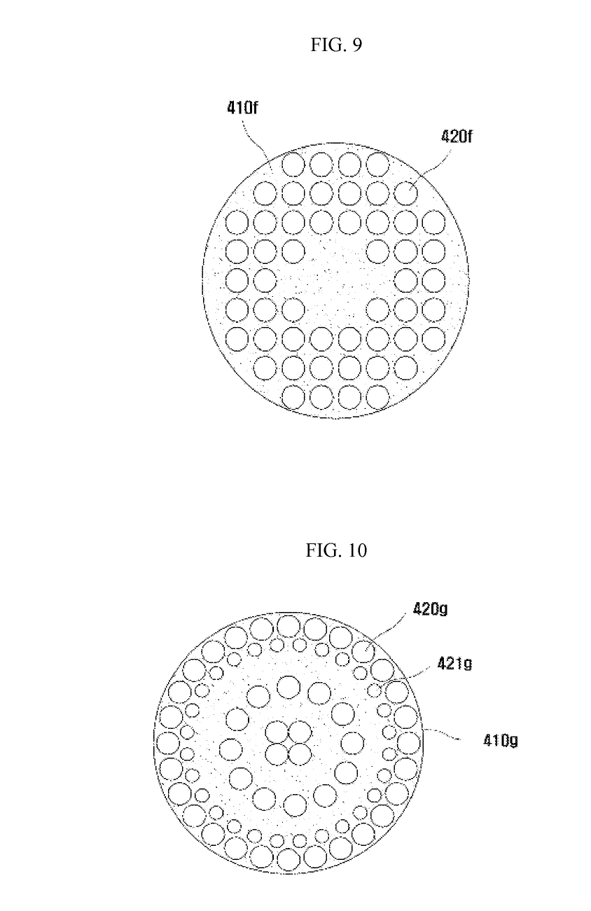

As illustrated in FIGS. 8 and 9, the island portions may be located at the center of the island-in-the-sea yarn or the sea portion may not be located at the center of the island-in-the-sea yarn.

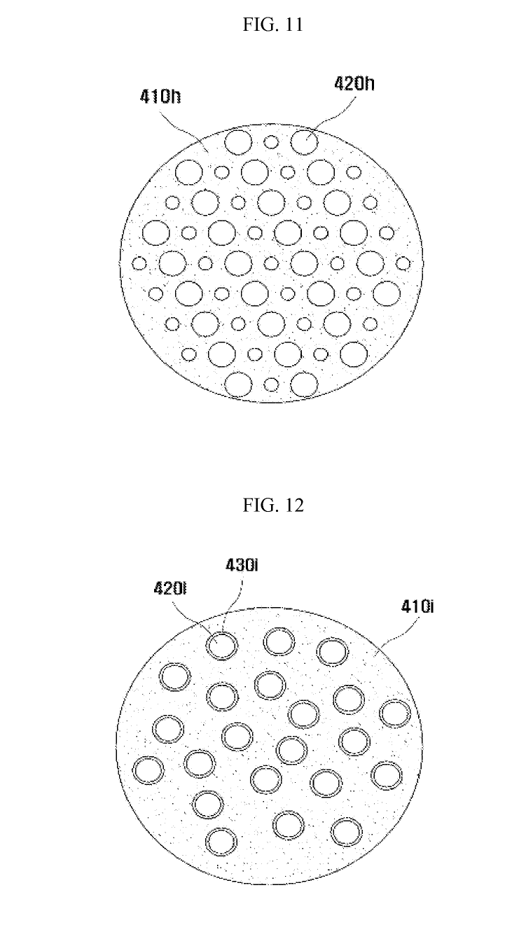

In some embodiments, the island portions may not necessarily have the same size. For example, as illustrated in FIGS. 10 and 11, the island-in-the-sea yarn may comprise island portions 420g and 421g having a different size of cross-sections. In this specific embodiment, one island portion 420g may have a relatively larger cross-section area than that of another island portion 421g. The island portions may correspond to two or more groups of different sizes and may have substantially different sizes. Furthermore, as shown in FIG. 12, an island portion 420i may be surrounded with a birefringent and/or isotropic sheath 430i.

Preferably, a plurality of the island portions may be disposed within the island-in-the-sea yarn, and the area ratio of the sea portions and the island portions may be preferably 2:8 to 8:2. The island-in-the-sea yarn may preferably have a single yarn fineness of 0.5 to 30 deniers and 500 to 4,000,000 (numbers/cm³) island-in-the-sea yarns may be preferably disposed within the sheet. Furthermore, the refractive index of the sea portion may be identical to that of the sheet of the luminance-enhanced film.

Meanwhile, the birefringent island-in-the-sea yarns may be arranged in the form of yarns or a fabric in the sheet. First, in the case where birefringent island-in-the-sea yarns are arranged in the form of yarns in the sheet, a plurality of birefringent island-in-the-sea yarns may preferably extend in one direction, and more preferably, the island-in-the-sea yarns may be arranged in the sheet vertically to a light source. In this case, optical modulation efficiency is maximized. Meanwhile, the island-in-the-sea yarns arranged in a row may be dispersed from one another, if appropriate, and the birefringent island-in-the-sea yarns may come in contact with one another or may be separated from one another. In the case where the island-in-the-sea yarns contact one another, they are close together to form a layer. For example, when three or more types of island-in-the-sea yarns, whose cross-sections have different diameters and are circular, are arranged, a triangle, which is obtained by interconnecting the centers of three circles adjacent to one another in the cross-sections perpendicular to their long axial directions, becomes a scalene. In addition, in the cross-sections taken perpendicular to the long axial directions of the island-in-the-sea yarns (cylindrical bodies), the cylindrical bodies are arranged such that the circle in a first layer contacts the circle in a second layer, the circle in the second layer contacts the circle in a third layer and the following layer contacts the next layer adjacent thereto. However, the condition that respective island-in-the-sea yarns contact two or more other island-in-the-sea yarns, which contact one another on the sides of their cylinders, on the side of the cylinder has only to be satisfied. Under this condition, a structure, in which the circle in the first layer contacts the circle in the second layer, the circle in the second layer and the circle in the third layer are spaced apart from each other through a support medium interposed therebetween, and the circle in the third layer contacts the circle in a fourth layer, may be designed.

It is preferred that the lengths of at least two sides of a triangle, which connects the centers of three circles directly contacting each other in the cross-sections perpendicular to the long axial direction of the island-in-the-sea yarn, be approximately identical. In particular, it is preferred that the lengths of three sides of the triangle be approximately identical. Further, in relation to a stack state of island-in-the-sea yarns in a thickness direction of the luminance-enhanced film, it is preferred that a plurality of layers be stacked such that two adjacent layers sequentially contact each other. Furthermore, it is more preferred that island-in-the-sea yarns in the form of cylinders having a substantially identical diameter be densely filled.

Accordingly, in such a more-preferred embodiment, the island-in-the-sea yarns have a cylindrical shape in which the diameters of circular cross-sections perpendicular to their long axial direction are substantially identical, and island-in-the-sea yarns located more inwardly than the outermost surface layer in the cross-section contact six other cylindrical island-in-the-sea yarns on the side of the cylinder.

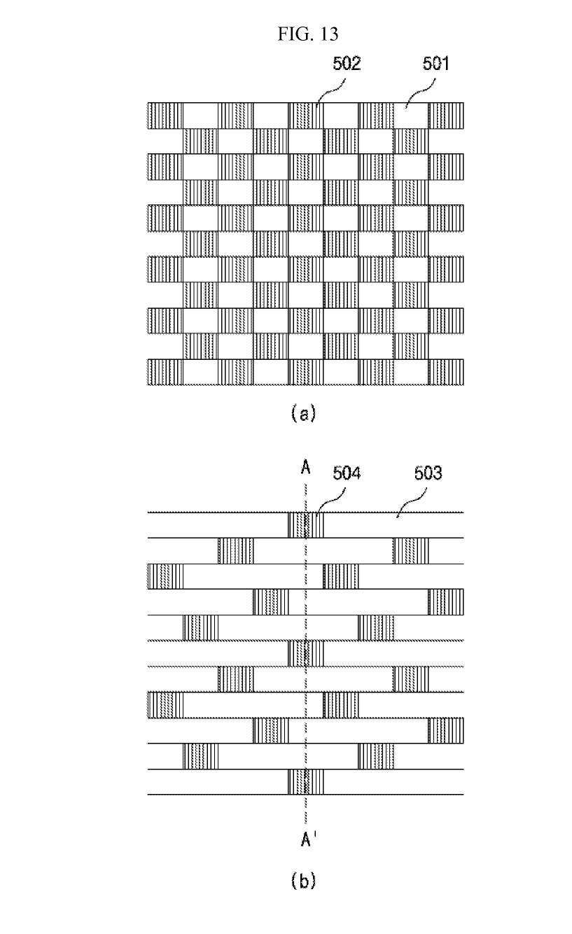

Meanwhile, the birefringent island-in-the-sea yarns may be arranged in the form of a fabric in the sheet (See FIGS. 13a and 5b). In this case, provided is a fabric comprising the birefringent island-in-the-sea yarns of the present invention as wefts and/or warps, and more preferably, provided is a fabric wherein the birefringent island-in-the-sea yarns of the present invention are used as one of wefts and warps and isotropic fibers are used as the other. Preferably, the wefts or warps may be interlaced with 1 to 200 threads of birefringent island-in-the-sea yarn. More preferably, a melting initiation temperature of the island portions may be higher than the melting temperature of the isotropic fibers. When the lamination of the fabric woven using these materials to a sheet interposed therebetween through applying a predetermined heat and pressure to the sheet is carried out at a temperature higher than the melting temperature of the fibers and lower than the melting initiation temperature of the island portions, the island portions dose not reach the melting initiation temperature and are thus not melted, but the fibers are partially or entirely melted, since the lamination is carried out at a the temperature higher than the melting temperature of the fibers. As a result, the fibers used as wefts or warps are melted in the lamination process and thus constitute the sheet, thus obtaining the final luminance-enhanced film in which only birefringent island-in-the-sea yarns are present. For this reason, the phenomenon, appearance of the fibers, which commonly occurs on the luminance-enhanced film comprising fibers, can be solved. The melting initiation temperature of the island portions may be preferably 30° C. higher than (more preferably, 50° C. higher than) the melting temperature of the isotropic fibers. Any fibers may be used without particular limitation, so long as they are woven with the birefringent island-in-the-sea yarns to form a fabric and meet the afore-mentioned temperature conditions. Preferably, the fibers may be optically isotropic, when taking into consideration the fact that they are perpendicularly woven with the birefringent island-in-the-sea yarns. This is because when the fibers are also birefringent, light modulated through birefringent island-in-the-sea yarns may pass through the fibers. Examples of fibers that can be used include polymer, natural and inorganic fibers (such as glass fibers), and combinations thereof. More preferably, the fibers may be the same material as the sea-portions.

Meanwhile, the fabric may be woven in an asymmetric structure such that more birefringent fibers are exposed to the surface thereof, as compared to isotropic fibers. The term “surface of a fabric” used herein refers to one of both sides of the fabric. The term “asymmetric structure” used herein refers to a fabric structure wherein intersections between warps and wefts are reduced, and one of warps and wefts are consecutively exposed longer to the surface of the fabric. The term “intersection” refers to a point at which a warp and a weft pass over and under each other and cross each other. Such an asymmetric structure minimizes presence of the pattern of fabric (the trace of intersections between warps and wefts) on the luminance-enhanced film. The luminance-enhanced film may be bound to the sheet fabric by a variety of methods such as vacuum hot-press lamination. The methods impart a fabric pattern to the luminance-enhanced film. That is, for example, it is preferred that after completion of vacuum hot-press lamination, the isotropic fibers are melted and lose their thread shapes. At this time, the birefringent fibers are deformed at the intersections between wefts and warps. As a result, the patterns of intersections remain on the luminance-enhanced film. As mentioned below, the intersection pattern may cause a moiré phenomenon on LCD screens.

Specifically, FIG. 13A illustrates a fabric having a symmetric structure. Referring to FIG. 13A, the fabric has a symmetric structure in which wefts 501 are vertically woven with warps 502, and the wefts 501 are repeatedly drawn over and under the warps 502, while intersecting the warps 502. FIG. 13B illustrates an asymmetric structure of the fabric according to one embodiment. Referring to FIG. 13B, the fabric is composed of birefringent island-in-the-sea yarns and isotropic fibers, acting as wefts 503 and warps 504, or warps 504 and wefts 503, respectively. The line A-A′ is a straight line parallel to the warps 504 including the intersections between the wefts 503 and the warps 504. Considering the asymmetric structure along the line A-A′, one isotropic fiber per five birefringent fibers is exposed to the surface of the fabric in the line A-A′ direction. Accordingly, when fabrics are woven in the asymmetric structure, more birefringent fibers than isotropic fibers are exposed on the surface thereof and the number of intersections can be reduced. In such an asymmetric structure, one isotropic fiber with respect to 5 to 16 birefringent fibers may be exposed to the surface of the fabric in the line A-A′ direction. When one isotropic fiber with respect to not more than 5 island-in-the-sea yarns is exposed to the surface of the fabric in the line A-A′ direction, more intersections exist between the birefringent fibers and isotropic fibers and thus cause the moiré on LCDs. When one isotropic fiber with respect to 16 or more island-in-the-sea yarns is exposed to the surface of the fabric in the line A-A′ direction, the fabric for improving luminance has low firmness and may thus cause adhesion failure.

The asymmetric structure of the fabric comprising birefringent island-in-the-sea yarns may have a variety of forms. As illustrated above, the asymmetric structure may be formed through a variety of combinations as well as the number of birefringent fibers per one isotropic fiber exposed to the surface in the line A-A′ direction. For example, although one isotropic fiber with respect to five birefringent fibers is exposed to the surface in the line A-A′ direction, a variety of combinations can be obtained, depending on the number of the wefts over which the intersections of adjacent isotropic fibers pass. When the fabric structure maintains a predetermined repeat pattern, such a combination may be limited. That is, a minimum weaving unit repeated up/down and left/right is generally referred to as “one repeat”. When the number of birefringent fibers with respect to one isotropic fiber exposed to the surface of the fabric in the A-A′ direction is determined, the number of possible one repeats is also determined depending on the number of birefringent fibers.

The asymmetric structure may not have a predetermined repeat pattern. In this case, in the asymmetric structure, 5 to 15-times as many birefringent fibers as the isotropic fibers are preferably exposed to the surface.

Meanwhile, the fabric of the present invention is preferably woven with 40 to 240 fibers/inch of the birefringent fibers and 20 to 240 fibers/inch of the isotropic fibers. When warps and wefts are woven as mentioned above, the fabric for luminance enhancement is excellent in optical modulation properties and production efficiency.

The birefringent fibers constituting the fabric may be interlaced with birefringent island-in-the-sea single yarns. In this case, each birefringent fiber is composed of 1 to 200 threads of birefringent island-in-the-sea single yarns. In addition, in this case, the birefringent island-in-the-sea single yarn preferably has a single yarn fineness of 0.5 to 30 deniers. This is because interlacing is easy and optical modulation is excellent within this range.

The fabric is produced in the form of a luminance-enhanced film and is thus applicable to a variety of optical devices. The luminance-enhanced film of the present invention is formed by combining the fabric comprising the birefringent island-in-the-sea yarns as wefts or warps with a film fabric. The film fabric may be composed of various materials which transmit light. As a method for combining the fabric to the film fabric, vacuum hot-press lamination may be used. In particular, when the fabric is applied to LCD devices, improved luminance can be imparted thereto. The fabric for luminance improvement is characterized in that it transmits only specific rotation direction of light, and optically modulates to scatter and reflect different rotation directions of light and vary their rotation. Accordingly, the fabric can increase the amount of light supplied to a liquid crystal panel. In addition, the fabric can reduce moiré on the screen of LCD devices. The moiré refers to a phenomenon in which interference patterns are created when two or more repeated wave patterns overlap due to a beating phenomenon. The moiré phenomenon may occur when light passes through a transmittance film having repeated patterns, and may be also occur due to fabric patterns. Accordingly, when the fabric comprising the birefringent island-in-the-sea yarns as wefts or warps is woven in an asymmetric structure, patterns of the fabric remain minimally on the luminance-enhanced film and occurrence of moiré phenomenon is thus reduced.

The sheet for luminance improvement of the present invention is used for not only LCDs, but also for other flat panel displays and can improve luminance or preventing the moiré phenomenon.

Meanwhile, it is preferable that the birefringent island-in-the-sea yarns have a volume of 1% to 90% with respect to the luminance-enhanced film of 1 cm³. When the volume of the island-in-the-sea yarn is 1% or less, a luminance-reinforcement effect is slight. When the volume of the island-in-the-sea yarn exceeds 90%, the amount of scattering due to the birefringent interface increases, disadvantageously causing optical loss.

Furthermore, the number of the birefringent island-in-the-sea yarns arranged in the luminance-enhanced film of 1 cm³ may 500 to 4,000,000. The island portions in the birefringent island-in-the-sea yarns may greatly affect optical modulation. When the cross-sectional diameters of the island portions in each birefringent island-in-the-sea yarn are smaller than optical wavelengths, refraction, scattering and reflection effects are decreased and optical modulation hardly occur. When the cross-sectional diameters of island portions are excessively large, light is normally reflected from the surface of island-in-the-sea yarns and diffusion in other directions is considerably slight. The cross-sectional diameters of island portions may be varied depending on an intended application of optical bodies. For example, the diameter of fibers may be varied depending on electromagnetic radiation wavelengths important for specific applications and different diameters of fibers are required to reflect, scatter or transmit visible, ultraviolet and infrared rays and microwaves.

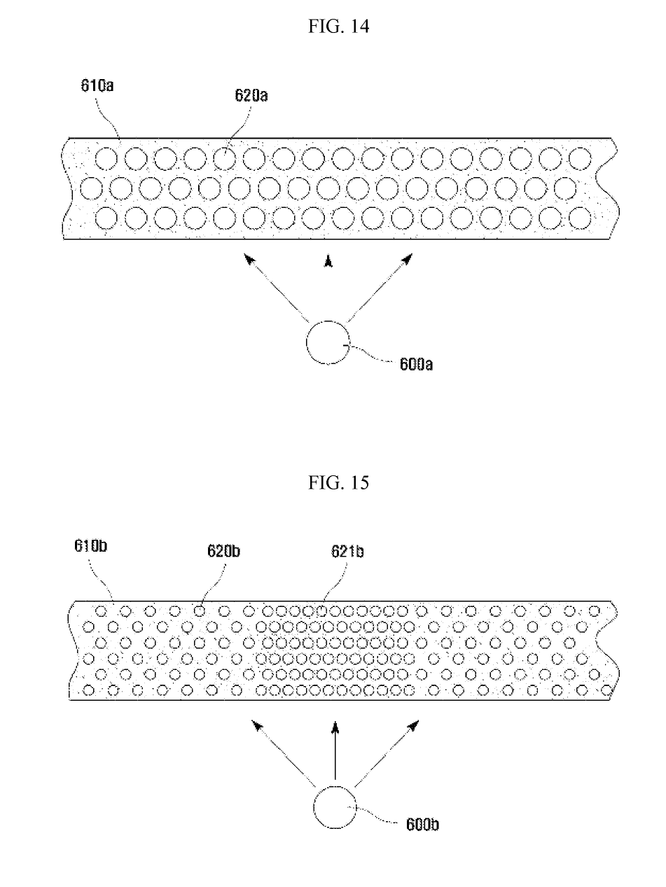

Meanwhile, the luminance-enhanced film of the present invention may have a structured surface layer according to intended applications. FIGS. 14 to 19 are sectional views illustrating the structured surface layer of the luminance-enhanced film according to the present invention. In FIG. 14, a light-incident surface and a light-emitting surface may be flush with light emitted from a light source 600a. In this case, as shown in FIG. 15, birefringent island-in-the-sea yarns 621b located on (adjacent to) a light source 600b are dense, while birefringent island-in-the-sea yarns 620b far from the light source 600b are sparse.

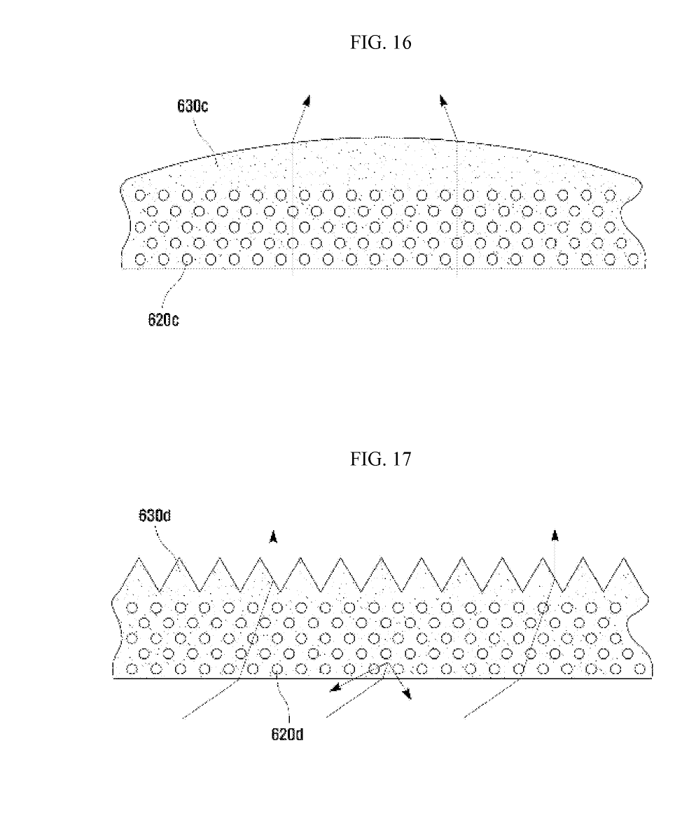

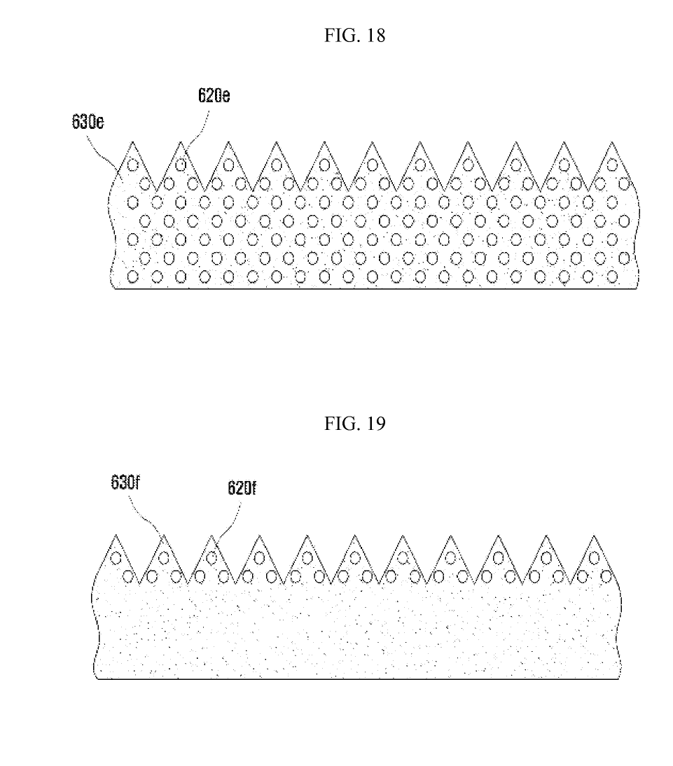

The structured surface layer may be formed on the side from which light is emitted. The structured surface layer may be in the form of a prism, lenticular or convex lens. More specifically, as shown in FIG. 16, the side on the luminance-enhanced film from which light is emitted may have a curved surface 630c in the form of a convex lens. The curved surface 630c may focus or defocus light permeated into the curved surface. Also, as shown in FIG. 17, the light-emitting surface may have a prism pattern 630d. In this case, birefringent island-in-the-sea yarns 620d may be not formed on the structure surface 630d, as shown in FIG. 17, or birefringent island-in-the-sea yarns 620e may be formed on both the sheet and a surface layer 630e, as shown in FIG. 18, or birefringent island-in-the-sea yarns 620f may be formed on only a surface layer 630f, as shown in FIG. 18.

A rear surface of the luminance-enhanced film is provided with a prominence/depression pattern formed by Matt treatment to impart scratch resistance thereto. This is performed within the scope that effects of the present invention pattern are not impaired.

Meanwhile, light emitted from a light source may be natural light or polarized light. Any birefringent island-in-the-sea yarn may be used so long as it is birefringent. It is preferred that the birefringent island-in-the-sea yarn be solid in view of orientation, stability of cross-section shape, or durability.

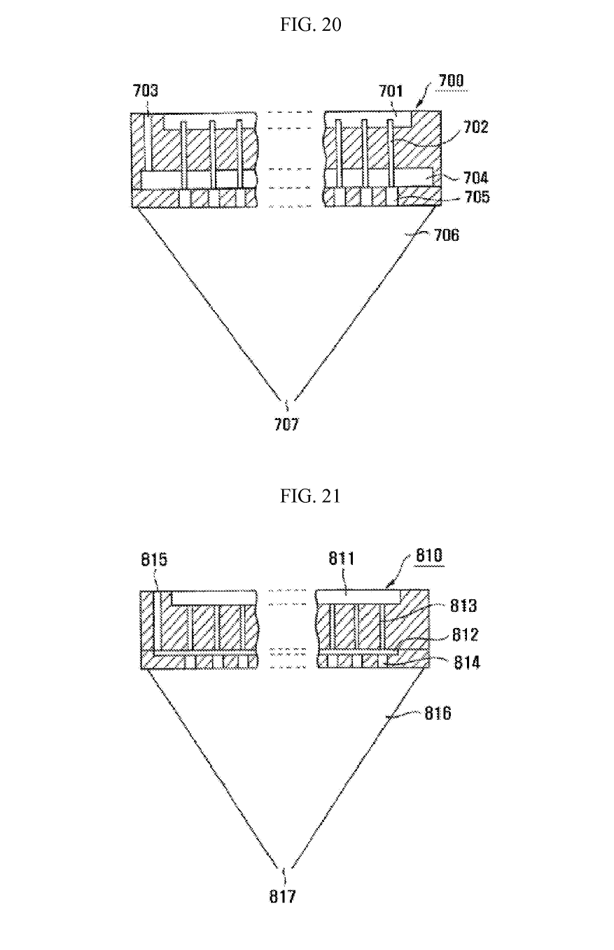

Next, a method for preparing birefringent island-in-the-sea yarns according to the present invention will be described. The birefringent island-in-the-sea yarns may be applied to any general method for preparing island-in-the-sea yarns without particular limitation. Any spinneret or spinning nozzle may be used without restriction of type so long as it enables preparation of birefringent island-in-the-sea yarns. Spinnerets or spinning nozzles having the substantially identical shape to the arrangement pattern of island portions on the cross-sections of birefringent island-in-the-sea yarns may be generally used. More specifically, any spinneret may be used so long as it can form island-in-the-sea yarns by combining island ingredients extruded from hollow pins or spinning nozzles suitably designed to partition island portions therein with a sea ingredient stream supplied from channels designed to fill the spaces provided therebetween, and extruding the combined stream from a discharge hole, while gradually thinning the stream, and island-in-the-sea yarns have two or more spinning centers. An example of spinnerets suitable for use is shown in FIGS. 20 and 21, and spinnerets that can be used in the present invention are not necessarily restricted thereto.

More specifically, FIG. 20 shows an example of a spinneret suitable for use in the present invention. More specifically, in the spinneret 700, a (melted) polymer for an island ingredient, present in an island-ingredient polymer storage 701 before being dispensed, is distributed through a plurality of hollow pins into a plurality of island-ingredient polymer channels 702, while a (melted) polymer for a sea ingredient is introduced through a plurality of sea-ingredient polymer channels 703 into a sea-ingredient polymer storage 704 before being dispensed. Each hollow pin constituting the island-ingredient polymer channels 702 passes through the sea-ingredient polymer storage 704 and opens downward with respect to the inlet center of a plurality of core-shell type combined-stream channels 705 arranged thereunder. The island-ingredient polymer streams are supplied from the bottom of island-ingredient polymer channels 702 to the center of core-shell type combined-stream channels 705, and the sea-ingredient polymer streams present in the sea-ingredient polymer storage 704 are introduced such that they surround the island-ingredient polymer streams present in the core-shell type combined-stream channels 705, to form a combined stream including the island-ingredient polymer streams as cores and the sea-ingredient polymer streams as shells. At this time, the cores are arranged such that they are grouped, based on two or more spinning centers. The core-shell type combined-streams are introduced into a combined-stream channel 706 having a funnel shape and the shells of core-shell type combined-streams present in the combined-stream channel 706 are then combined to form a sea-island type combined-stream. The sea-island type combined-stream is discharged from a discharge hole 707 arranged on the bottom of the funnel-shaped combined-stream channel 706, while flowing through the funnel-shaped combined-stream channel 706 and having a gradually-decreased horizontal cross-section.

FIG. 21 is an example of another preferred spinneret 810. For the spinneret 810, an island-ingredient polymer storage 811 is connected to a sea-ingredient polymer storage 812 through island-ingredient polymer channels 813 including a plurality of holes, the island-ingredient polymer (melted) present in the island-ingredient polymer storage 811 is distributed through a plurality of island-ingredient polymer channels 813 and is then introduced into a sea-ingredient polymer storage 812. Meanwhile, the sea-ingredient polymer is introduced through a sea-ingredient polymer channel 815 into a sea-ingredient polymer storage 812. Meanwhile, the island-ingredient polymer introduced into the sea-ingredient polymer storage 812 passes through the sea-ingredient polymer (melted) accepted in the sea-ingredient polymer storage 812, is then introduced into core-shell type combined-stream channels 814 and flows downward in the center thereof. Meanwhile, the sea-ingredient polymer present in the sea-ingredient polymer storage 812 flows downward such that it surrounds the island-ingredient polymer streaming downward through the center of the core-shell type combined-stream channels 814. As a result, a plurality of core-shell type combined-streams are formed in a plurality of core-shell type combined-stream channels 814 and then flows downward in a funnel-shape combined-stream channel 816. As a result, like the spinneret as shown in FIG. 20, sea-island type combined streams are formed, flow downward and are then discharged from a discharge hole 817 arranged on the bottom of a funnel-shaped combined-stream channel 816, while having a gradually-decreased horizontal cross-section. Finally, birefringent island-in-the-sea yarns of the present invention are prepared.

Consequently, unlike conventional birefringent island-in-the-sea yarns, the birefringent island-in-the-sea yarns according to the present invention can form birefringent interfaces even in fibers and are thus practically applicable to commercial production due to high optical modulation efficiency. Furthermore, when materials for island portions and sea portions are specified, the birefringent island-in-the-sea yarns can realize superior optical modulation efficiency, as compared to conventional birefringent island-in-the-sea yarns.

Furthermore, in the case where a composite fiber is prepared by twisting several to several tens of island-in-the-sea yarns, for example, a composite fiber is prepared by twisting 10 island-in-the-sea yarns, the composite fiber has 100 birefringent interfaces and thus causes at least 100 times of optical modulation. Furthermore, in the case where island-in-the-sea yarns composed of several threads are prepared, for example, island-in-the-sea yarns composed of 10 threads, the composite fiber prepared from the yarns has 100 birefringent interfaces and thus causes at least 100 times of optical modulation. The island-in-the-sea yarns of the present invention may be prepared by a method such as co-extrusion and is not limited thereto.

Accordingly, while conventional island-in-the-sea yarns utilize only island portions left behind after melting sea portions, as microfibers, irrespective of birefringency, the present invention utilizes island-in-the-sea yarns comprising sea portions and island portions having different optical properties, instead of melting the sea portions of island-in-the-sea yarns. In order to accomplish objects of the present invention, the present invention adopts the case where island portions are anisotropic and sea portions are isotropic and vice versa.

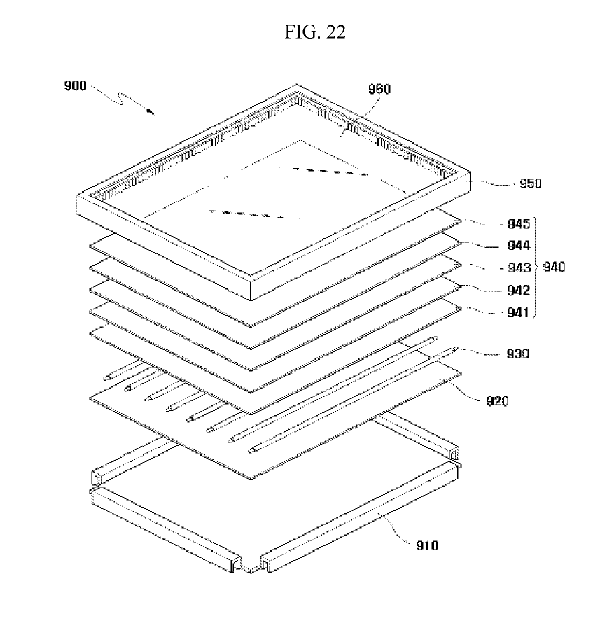

Meanwhile, in accordance with another aspect of the present invention, provided is an LCD device, comprising the luminance-enhanced film. Specifically, FIG. 22 shows an LCD device using the luminance-enhanced film according to one embodiment. In FIG. 22, a reflection plate 920, a plurality of cold cathode fluorescent lamps 930 and an optical film 940 are arranged on a frame 910 in this order from the bottom. The optical film 940 includes a diffusion plate 941, a light-diffusing film 942, a prism film 943, a luminance-enhanced film 944 and a polarized light-absorbing film 945 stacked in this order from the bottom. The stack order may be varied depending on intended purposes, or the elements may be omitted or provided in plural number. For example, the diffusion plate 941, the light-diffusing film 942 and the prism film 943 may be omitted, and the stack order or position thereof may be varied. Furthermore, other elements such as a phase-contrast film (not shown) may be inserted into the LCD device in a suitable position. Meanwhile, a liquid crystal display panel 960 placed in a mold frame 950 may be arranged on the optical film 940. In addition, LEDs may be used as light sources, instead of the cold cathode fluorescent lamps 930.

The principle of the LCD device will be illustrated according to the passage of light. Light is irradiated from a backlight 230 and then transferred to the diffusion plate 941 of the optical film 940. Then, the light passes through the light-diffusing film 942 so that it can be directed vertical to the optical film 940. Then, the light passes through the prism film 943, arrives on the luminance-enhanced film 944 and at this time, undergoes optical modulation. Specifically, P-waves pass through the luminance-enhanced film 944 without optical loss. On the other hand, S waves undergo optical modulation (e.g., reflection, scattering, refraction), are reflected on the reflection plate 920 arranged on the rear surface of the cold cathode fluorescent lamp 930, are randomly converted into P- or S waves, and pass through the luminance-enhanced film 944 again. Then, the waves pass through the polarized light-absorbing film 945 and arrive on the liquid crystal display panel 960. As a result, it is expected that the LCD device into which the luminance-enhanced film of the present invention is introduced based on the afore-mentioned principle can considerably enhance luminance, as compared to the case of conventional luminance-enhanced films.

Meanwhile, the use of the luminance-enhanced film is described for LCDs, but is not limited thereto. That is, the luminance-enhanced film may be widely used in flat panel displays such as projection displays, plasma display panels (PDPs), field emission displays (FEDs) and electro-luminescent displays (ELDs).

Hereinafter, the following Examples and Experimental Examples will be provided for a further understanding of the invention. These examples are for illustrative purposes only and are not intended to limit the scope of the present invention.

### Example 1

An isotropic PC alloy (nx=1.57, ny=1.57, nz=1.57) consisting of polycarbonate and modified polycyclohexylenedimethylene terephthalate glycol (PCTG) in a ratio of 5:5 was used as a sea ingredient, anisotropic PEN (nx=1.88, ny=1.57, nz=1.57) was used as an island ingredient and the number of the island portions arranged was 200. Under this composition, 150/24 undrawn yarns were spun at a spinning temperature of 305° C. and at a spinning rate of 1,500 M/min and then drawn 3-fold to obtain 50/24 drawn yarns of birefringent fibers. A fabric was woven using the island-in-the-sea yarns thus prepared and the isotropic PC alloy fibers as wefts and as warps, respectively. At this time, the fabric was woven in an asymmetric structure such that one isotropic fiber with respect to six birefringent fibers was exposed to the surface of the fabric in an isotropic fiber arrangement direction. Then, the island-in-the-sea yarn fabric was placed on two PC alloy sheets (composed of the same material and have the same optical properties as the sea portions of the birefringent island-in-the-sea yarns) and was pressed by a predetermined pressure to laminate the island-in-the-sea yarn-woven fabric to the PC alloy sheets. Then, a mixed UV-curable coating resin of epoxy acrylate and urethane acrylate having a refractive index of 1.54 was coated on the fabric-laminated PC alloy sheets and in a region in which a mirror surface roll is introduced, and was primarily and secondarily UV cured to prepare a composite sheet in which birefringent island-in-the-sea yarns are laminated. The coating resin had a refractive index of 1.54 before UV coating curing, while it had a refractive index of 1.57 after curing. A luminance-enhanced film with a thickness of 400 μm was fabricated.

### Example 2

A luminance-enhanced film was fabricated in the same manner as in Example 1 except that an isotropic PC alloy consisting of polycarbonate and modified polycyclohexylene dimethylene terephthalate glycol (PCTG) in a ratio of 3:7 was used as a material for island portions and sheets.

### Example 3

A luminance-enhanced film was fabricated in the same manner as in Example 1 except that an isotropic PC alloy consisting of polycarbonate and modified polycyclohexylene dimethylene terephthalate glycol (PCTG) in a ratio of 7:3 was used as a material for island portions and sheets.

### Example 4

A luminance-enhanced film was fabricated in the same manner as in Example 1 except that isotropic Co-PEN (nx=1.57, ny=1.57, nz=1.57) was used as a material for sea portions and sheets.

### Example 5

A luminance-enhanced film was fabricated in the same manner as in Example 1 except that polycarbonate was used as a material for sea portions and sheets.

### Example 6

A luminance-enhanced film was fabricated in the same manner as in Example 1 except that an isotropic PC alloy consisting of polycarbonate and modified polycyclohexylenedimethylene terephthalate glycol (PCTG) in a ratio of 1:9 was used as a material for sea portions and sheets.

### Example 7

A luminance-enhanced film was fabricated in the same manner as in Example 1 except that an isotropic PC alloy consisting of polycarbonate and modified polycyclohexylenedimethylene terephthalate glycol (PCTG) in a ratio of 9:1 was used as a material for sea portions and sheets.

### Comparative Example 1

A luminance-enhanced film with a thickness of 400 μm was fabricated in the same manner as in Example 1 except that isotropic birefringent island-in-the-sea yarns whose island portions are composed of isotropic PET (nx=ny=nz=1.57) and whose sea portions are composed of isotropic Co-PEN (nx=ny=nz=1.57) were used.

### Comparative Example 2

A PEN resin of IV 0.53 was polymerized to prepare 150/24 undrawn yarns, instead of the birefringent island-in-the-sea yarns used in Example 1. At this time, the yarns were spun at a spinning temperature of 305° C. and a spinning rate of 1,500 m/min. The obtained yarns were drawn three-fold at a temperature of 150° C. to prepare 50/24 drawn yarns. The PEN fibers showed birefrigence and had refractive indices of nx=1.88, ny=1.57 and nz=1.57 in respective directions. A luminance-enhanced film with a thickness of 400 μm was fabricated in the same manner as Example 1 except that the birefringent PEN fibers were used, instead of the island-in-the-sea yarns of Example 1.

### Comparative Example 3

A luminance-enhanced film was fabricated in the same manner as in Example 1 except that birefringent island-in-the-sea yarns whose island portions are composed of syndiotactic polystyrene (nx=1.57, ny=1.61 and nz=1.61) were used.

### Comparative Example 4

A luminance-enhanced film was fabricated in the same manner as in Example 1 except that birefringent island-in-the-sea yarns whose island portions are composed of isotropic PET (nx=1.69, ny=1.54 and nz=1.54) were used.

### Experimental Example

The following physical properties of the luminance-enhanced films fabricated in Example 1 to 3 and Comparative Example 1 to 4 were evaluated and the results thus obtained are shown in Table 1 below.

### 1. Luminance

The following tests were performed, in order to measure the luminance of the luminance-enhanced films thus fabricated. A panel was assembled on a 32″ direct lighting type backlight unit provided with a diffusion plate, two diffusion sheets, and the luminance-enhanced film, and luminance at 9 points was measured using a BM-7 tester (TOPCON, Corp. Korea), and an average luminance value was obtained and shown.

### 2. Transmittance

Transmittance was measured in accordance with ASTM D1003 using a COH300A analyzer (NIPPON DENSHOKU Co., Ltd. Japan).

### 3. Degree of Polarization

The degree of polarization was measured using an RETS-100 analyzer (OTSKA Co., Ltd., Japan).

### 4. Moisture Absorption

The luminance-enhanced film was immersed in water at 23 r for 24 hours in accordance with ASTM D570 and variation in sample wt % before and after treatment was measured.

### 5. Sheet Sprout

The luminance-enhanced film was assembled in a 32-inch backlight unit, stood in a thermo-hygrostat at RH 75%, 60° C. for 96 hours and then disassembled. A sprout level of the luminance-enhanced film was observed with the naked eye and the results thus obtained were marked by ∘, Δ or x.

### ∘: Good, Δ: Normal, x: Bad

### 6. UV-Resistance

The luminance-enhanced film was irradiated using a 130-mW ultraviolet lamp (365 nm) at a height of 10 cm using SMDT51H (SEI MYUNG VACTRON CO., LTD. Korea) for 10 minutes. Yellow index (YI) before and after treatment was measured using an SD-5000 analyzer (NIPPON DENSHOKU Co., Japan) and a yellowing level was thus evaluated.

TABLE 1

| | | | Degree of | Moisture | | |
|---|---|---|---|---|---|---|
| | Luminance | Transmittance | polarization | absorption | Sheet | UV- |
| | (cd/m²) | (%) | (%) | (%) | sprout | resistance |
| Ex. 1 | 400 | 52 | 78 | 0.24 | ◯ | 2.3 |
| Ex. 2 | 380 | 52 | 75 | 0.24 | ◯ | 2.0 |
| Ex. 3 | 380 | 52 | 75 | 0.24 | ◯ | 2.0 |
| Ex. 4 | 375 | 53 | 74 | 0.24 | ◯ | 2.5 |
| Ex. 5 | 350 | 55 | 70 | 0.24 | ◯ | 2.0 |
| Ex. 6 | 360 | 50 | 72 | 0.24 | ◯ | 2.0 |
| Ex. 7 | 360 | 50 | 72 | 0.24 | ◯ | 2.0 |
| Comp. Ex. 1 | 270 | 85 | 2 | 0.24 | ◯ | 1.5 |
| Comp. Ex. 2 | 320 | 55 | 50 | 0.24 | ◯ | 1.8 |
| Comp. Ex. 3 | 305 | 79 | 25 | 0.24 | ◯ | 2.0 |
| Comp. Ex. 4 | 310 | 78 | 30 | 0.24 | ◯ | 2.0 |

As can be seen from Table 1, the luminance-enhanced films comprising the birefringent island-in-the-sea yarns (Examples 1 to 7) according to the present invention exhibited superior overall optical properties, as compared to the luminance-enhanced films not comprising the birefringent island-in-the-sea yarns (Comparative Examples 1 to 4), in particular, as compared to the cases where island portions are composed of different isotropic materials (Comparative Examples 3 and 4). Meanwhile, it can be confirmed that the case wherein polycarbonate and modified polycyclohexylenedimethylene terephthalate glycol (PCTG) as materials for sea portions and sheets were present within a ratio of 15:85 to 85:15 exhibited superior luminance improvement effects, as compared to other cases (Examples 4 to 7).

### Examples 8-9 & Comparative Examples 5-7

### Example 8

A luminance-enhanced film was fabricated in the same manner as in Example 1 except that one isotropic fiber with respect to 10 birefringent fibers was exposed to the surface of the fabric in an isotropic fiber arrangement direction.

### Example 9

A luminance-enhanced film was fabricated in the same manner as in Example 1 except that the fabric was woven such that one isotropic fiber with respect to 15 birefringent fibers was exposed to the surface of the fabric in an isotropic fiber arrangement direction.

### Example 10

A luminance-enhanced film with a thickness of 400 μm was fabricated in the same manner as in Example 1 except that the fabric was woven such that one isotropic fiber with respect to 10 birefringent fibers was exposed to the surface of the fabric in an isotropic fiber arrangement direction.

### Comparative Example 5

A luminance-enhanced film with a thickness of 400 μm was fabricated in the same manner as in Example 1 except that isotropic birefringent island-in-the-sea yarns whose island portions are composed of isotropic PET (nx=ny=nz=1.57) and whose sea portions are composed of isotropic Co-PEN (nx=ny=nz=1.57) were used.

### Comparative Example 6

A luminance-enhanced film with a thickness of 400 μm was fabricated in the same manner as in Example 1 except that the fabric was woven such that one warp with respect to two wefts was exposed to the surface of the fabric in a warp direction.

### Comparative Example 7

A luminance-enhanced film with a thickness of 400 μm was fabricated in the same manner as in Example 1 except that the fabric was woven in a symmetric structure.

### Experimental Example

The following physical properties of the luminance-enhanced films fabricated in Examples and Comparative Examples were evaluated and the results thus obtained are shown in Table 2 below.

1. Moiré test

A panel was assembled on a 32″ direct lighting type backlight unit provided with a diffusion plate, two diffusion sheets, and moiré was evaluated with the naked eye based on four grades, i.e., very weak, weak, medium and strong.

TABLE 2

| | | | Degree of | |
|---|---|---|---|---|
| | Luminance | Transmittance | polarization | |
| | (cd/m²) | (%) | (%) | Moire |
| Ex. 1 | 400 | 52 | 78 | Very weak |
| Ex. 8 | 400 | 52 | 78 | Very weak |
| Ex. 9 | 400 | 52 | 78 | Very weak |
| Comp. Ex. 4 | 270 | 85 | 2 | Very weak |
| Comp. Ex. 5 | 400 | 52 | 78 | Medium |
| Comp. Ex. 6 | 400 | 52 | 78 | Strong |

As can be seen from Table 2, the LCD devices to which the fabric comprising the birefringent island-in-the-sea yarns of the present invention was applied (Examples 1, 8 and 9), exhibited superior overall optical properties, as compared to LCD devices to which the fabric was not applied (Comparative Examples 4 to 6). More specifically, the cases where birefringent island-in-the-sea yarns whose island portions and sea portions exhibited identical optical properties were used exhibited superior luminance, as compared to the case where birefringent island-in-the-sea yarns whose island portions and sea portions exhibited different optical properties were used (Comparative Example 4). As a result of tests for luminance-enhancement films, Comparative Example 4 exhibited low polarization and high transmittance, as compared to other Examples and Comparative Examples. On the other hand, as a result of tests for assembled LCD devices, Examples 1, 8 and 9 and Comparative Examples 5 and 6, wherein luminance-enhancement films perform optical modulation, exhibited high luminance, as compared to Comparative Example 4. Meanwhile, moiré was strong and medium in the case where the fabric was woven in a symmetric structure (Comparative Example 6), and the case wherein the fabric was woven such that one warp with respect to two wefts was exposed to the surface of the fabric in a warp direction (Comparative Example 5), respectively, while the moiré phenomenon was very weak in all Examples and Comparative Example 1.

The luminance-enhanced film of the present invention exhibits superior optical modulation performance and may thus be widely utilized in optical devices such as cameras, cellular phones, electro-luminescent displays (ELDs) and high luminance-requiring LCD devices.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

What is claimed is:

1. A luminance-enhanced film comprising:
a sheet; and
a plurality of birefringent island-in-the-sea yarns arranged in the sheet,
wherein each island-in-the-sea yarn comprises island portions composed of polyethylene naphthalate (PEN) and a sea portion composed of a material selected from copolyethylene naphthalate (co-PEN), polycarbonate (PC), a polycarbonate alloy and a combination thereof.

2. The luminance-enhanced film according to claim 1, wherein the sheet is isotropic.

3. The luminance-enhanced film according to claim 1, wherein the polycarbonate alloy consists of polycarbonate and modified polycyclohexylenedimethylene terephthalate glycol (PCTG).

4. The luminance-enhanced film according to claim 3, wherein the polycarbonate and the modified polycyclohexylenedimethylene terephthalate glycol (PCTG) are present in a weight ratio of 15:85 to 85:15.

5. The luminance-enhanced film according to claim 3, wherein the polycarbonate and the modified polycyclohexylenedimethylene terephthalate glycol (PCTG) are present in a weight ratio of 4:6 to 6:4.

6. The luminance-enhanced film according to claim 1, wherein a birefringent interface is formed on the boundary between the island portion and the sea portion.

7. The luminance-enhanced film according to claim 1, wherein a difference in refractive index between the sheet and the island-in-the-sea yarn with respect to two axial directions is 0.05 or less and a difference in refractive index between the sheet and the island-in-the-sea yarn with respect to the remaining one axial direction is 0.1 or more.

8. The luminance-enhanced film according to claim 1, wherein assuming that x-, y- and z-axis refractive indexes of the sheet are nX1, nY1 and nZ1, respectively, and the x-, y- and z-axis refractive indexes of the island-in-the-sea yarn are nX2, nY2 and nZ2, respectively, at least one of x-, y- and z-axis refractive indexes of the sheet is equivalent to that of the birefringent island-in-the-sea yarn.

9. The luminance-enhanced film according to claim 8, wherein the refractive indexes of the birefringent island-in-the-sea yarn are nX2>nY2=nZ2.

10. The luminance-enhanced film according to claim 1, wherein a difference in refractive index between the sea portion and the island portion with respect to two axial directions is 0.05 or less and a difference in refractive index between the sea portion and the island portion with respect to the remaining one axial direction is 0.1 or more.

11. The luminance-enhanced film according to claim 10, wherein assuming that x- (longitudinal), y- and z-axis refractive indexes of the island portion are nX3, nY3 and nZ3, respectively, and the x-, y- and z-axis refractive indexes of the sea portion are nX4, nY4 and nZ4, respectively, at least one of x-, y- and z-axis refractive indexes of the island portion is equivalent to that of the sea portion.

12. The luminance-enhanced film according to claim 11, wherein an absolute value of the difference in refractive index between nX3 and nX4 is 0.1 or more.

13. The luminance-enhanced film according to claim 1, wherein the refractive index of the sea portion in the island-in-the-sea yarns is equivalent to the refractive index of the sheet.

14. The luminance-enhanced film according to claim 1, wherein an area ratio of the sea portion and the island portions is 2:8 to 8:2, based on the cross-section of the island-in-the-sea yarn.

15. The luminance-enhanced film according to claim 1, wherein the luminance-enhanced film has a structured surface layer.

16. The luminance-enhanced film according to claim 1, wherein the birefringent island-in-the-sea yarns are woven into a fabric, wherein the fabric is woven using the birefringent island-in-the-sea yarns as one of wefts and warps, and fibers as the other thereof, wherein the island portions have a melting initiation temperature higher than a melting temperature of the fiber.

17. The luminance-enhanced film according to claim 16, wherein the fibers are isotropic fibers.

18. The luminance-enhanced film according to claim 16, wherein the fibers are selected from the group consisting of polymer, natural and inorganic fibers, and combinations thereof.

19. The luminance-enhanced film according to claim 16, wherein the fabric is woven in an asymmetric structure such that more birefringent island-in-the-sea yarns than isotropic fibers are exposed to the surface of the fabric.

20. The luminance-enhanced film according to claim 19, wherein one isotropic fiber with respect to 5 to 16 birefringent island-in-the-sea yarns is exposed in one direction to the surface of the fabric.

21. The luminance-enhanced film according to claim 19, wherein the fabric was woven in an asymmetric structure such that 5 to 16 times as many birefringent island-in-the-sea yarns as isotropic fibers are exposed to the surface of the fabric.

22. The luminance-enhanced film according to claim 16, wherein the island portion is birefringent and the sea portion is isotropic.
